(19) United States
(12) Patent Application Publication
(10) Pub. No.: US 2007/0245347 A1
(43) Pub. Date: Oct. 18, 2007

(54) INSTALLATION METHOD AND COMMUNICATION APPARATUS

(76) Inventors: Takashi Oya, Yokohama-shi (JP); Yasunari Fujii, Kawasaki-shi (JP); Tsuneyoshi Takagi, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/690,913

(22) Filed: Mar. 26, 2007

(30) Foreign Application Priority Data
Apr. 14, 2006 (JP) 2006-112756

(51) Int. Cl. G06F 9/445

(52) U.S. Cl. 717/176; 717/174

(57) ABSTRACT

A communication device detects a network device, and determines software to be used by a communication device and the detected device to cooperate with each other. The communication device and the detected device then respectively install the determined software.

### BACKGROUND OF THE INVENTION

1. Field of the Invention

The present invention relates to an installation method, a communication apparatus and a computer program.

2. Description of the Related Art

Video recorders and television sets equipped with LAN (Local Area Network) connect functions are commercially available. Such television sets are capable of obtaining via a network and displaying still images and video stored in a recorder. DLNA (Digital Living Network Alliance) is a known standard regarding such exchanging of still images or moving images.

Meanwhile, there are communication adapters which add network communication functions to input/output devices not equipped with network functions. For instance, a commercially-available print server adds a LAN function to a printer provided with a USB (Universal Serial Bus) interface. In addition, through the use of such an external communication adapter, a network function may be added to an input/output device such as a digital camera, a printer or a scanner that is not equipped with a network function.

Updating of firmware in a device not connected to a network is generally performed via an interface such as USB, or via media such as a CF (CompactFlash) card. In contrast, updating of embedded software of a network-connected device may be performed via the network in the same manner that a personal computer would be updated. For instance, a technique in which software is distributed from an installation server to a plurality of clients and the clients then notify completion of installation to the server is disclosed in Japanese Patent Laid-Open No. 2000-40003.

In addition, a technique in which a printer port is automatically created and driver software is installed upon detection of a printer on a network by a computer is disclosed in Japanese Patent Laid-Open No. 2002-366502. Furthermore, United States Patent Application Publication No. 2005/198222 presents an example of dynamically changing and restructuring input/output device configuration via a network.

Moreover, an example of controlling a plurality of services to extract demand characteristics and dynamically determining a method for providing each service is presented in Japanese Patent Laid-Open No. 2005-100320.

As described above, updating of software of devices connected to a network is generally performed on a per-device basis, regardless of whether or not such updating is performed via the network.

However, with a system that combines a plurality of devices, merely updating software of individual devices on an individual basis is insufficient, and any updating of software must also involve updating software of a peer device.

In this case, installing in advance software corresponding to all possible combinations will be difficult when considering the increase in device types and in the capacities of communication adapters.

Additionally, in the case of an external communication adapter, since there is no way of knowing in advance which device the adapter will be connected to, it is necessary to select and install appropriate software after the device is identified.

Furthermore, conventional arrangements are unable to address cases in which functions are insufficient when executing a new service.

### SUMMARY OF THE INVENTION

The present invention realizes to install necessary software according to a connection status of a device.

According to one aspect of the present invention, there is provided a software installation method, comprising the steps of: detecting a device on a network; determining software to be used by each of a plurality of devices including the detected device to allow the plurality of devices to cooperate with each other; and installing the determined software to each of the plurality of devices.

According to another aspect of the present invention, there is provided a communication apparatus that cooperates with a device on a network, comprising: detection means for detecting a device on the network; and notification means for notifying the device on the network of software to install in order to cooperate with the device on the network.

According to still another aspect of the present invention, there is provided a communication apparatus that cooperates with a device on a network, comprising: detection means for detecting a device on the network; installation means for installing software to be installed in order to cooperate with the device on the network; and notification means for notifying the device on the network of information to be used to determine software to be installed in order to cooperate with the device on the network.

Further features of the present invention will become apparent from the following description of exemplary embodiments with reference to the attached drawings.

### BRIEF DESCRIPTION OF THE DRAWINGS

FIG. 1 is a diagram showing an example of a configuration of a system according to a first embodiment;

FIG. 2 is a diagram showing an example of a hardware configuration of a communication adapter;

FIG. 3 shows a system configured of a plurality of input/output devices connected to a network 170 via communication adapters in the same manner as the system shown in FIG. 1;

FIG. 4 is a diagram showing contents of installation information according to the first embodiment;

FIG. 5 is a diagram showing an example of an XML-format description of the contents of installation information shown in FIG. 4;

FIG. 6 is a diagram showing an example of a GUI displaying an installation application on an input/output device;

FIGS. 7A and 7B are diagrams showing a procedure of processing performed by a display adapter 102 for determining installation to another communication adapter;

FIGS. 8A and 8B are diagrams showing a procedure of processing when each communication adapter on a network performs installation determination;

FIG. 9 is a diagram showing an example of an installation module list;

FIG. 10 is a diagram in which the installation module list shown in FIG. 9 is represented as a description file;

FIG. 11 is a diagram showing an example of a configuration of a video output system that supports video distribution services;

FIG. 12 is a diagram showing a sequence and processing flow between devices according to a seventh embodiment;

FIG. 13 is a flowchart showing details of processing of a video distribution service 1121 shown in FIG. 12;

FIG. 14 is a flowchart showing details of processing performed by a video display control device 1102 shown in FIG. 12;

FIG. 15 is a flowchart showing details of processing performed by the video display control device 1102 shown in FIG. 12;

FIG. 16 is a diagram showing a configuration of a service list DB 1122;

FIG. 17 is a diagram showing a configuration of a device status DB 1104;

FIG. 18 is a diagram showing configurations of device function module list DBs 1103 and 1113;

FIG. 19 is a diagram showing an example of a configuration of the video display control device 1102; and

FIG. 20 is a diagram showing an example of a configuration of a video output control device 1112.

### DESCRIPTION OF THE EMBODIMENTS

Preferred embodiments of the present invention will now be described in detail with reference to the accompanying drawings.

### First Embodiment

In a first embodiment, based on installation information, a communication adapter (communication device) connected to a display instructs another communication adapter (communication device) connected to a network to install a software module. In other words, the communication device detects another network device, and determines software to be respectively used by the communication device and the other device to cooperate with each other. Next, the communication device and the other device respectively install the determined software.

Hereinafter, a communication adapter connected to a display shall be referred to as a “display adapter”. In addition, application software shall be simply referred to as “application”.

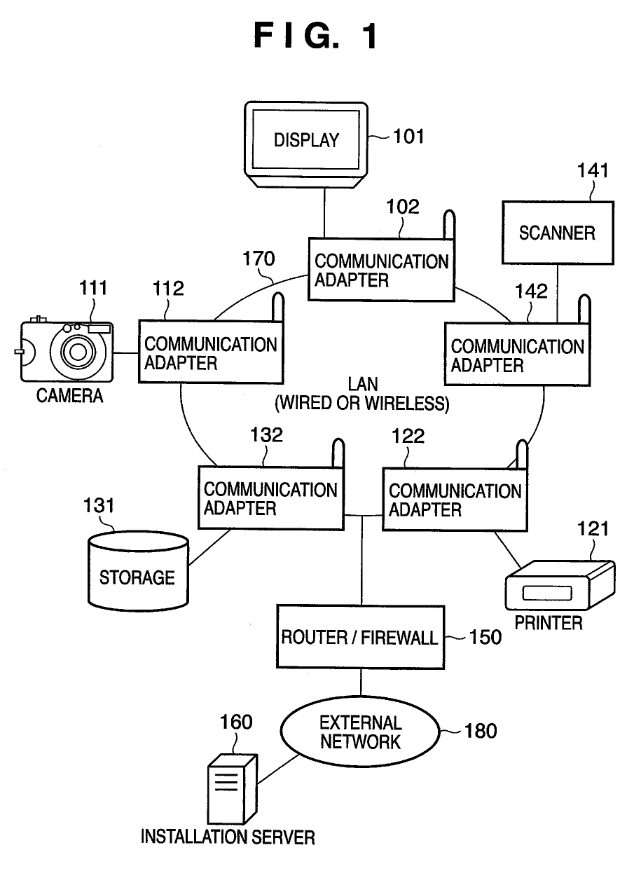

FIG. 1 is a diagram showing an example of a configuration of a system according to the first embodiment. The system is formed so that communication adapters (communication devices) connected to a plurality of input/output devices are connected by a network (LAN) 170. In the example shown in FIG. 1, input/output devices and communication adapters are, namely: a display 101 and a display adapter 102; a camera 111 and a camera adapter 112; a printer 121 and a printer adapter 122; and a scanner 141 and a scanner adapter 142. Note that, while the names of the devices have been assigned to the communication adapters for the sake of convenience, the respective communication adapters share a common specification and may be connected to any of the input/output devices. It is obvious that there are also communication adapters designed for specific devices. Thus, an embodiment is also possible including, for instance, a communication adapter for a camera, which is provided with a camera platform capable of pan/tilt control. In addition, the input/output devices and communication adapters are respectively equipped with software for performing control.

It is to be understood that the communication adapters are connected to the devices via interfaces such as USBs, and therefore capable of controlling the devices via the network. For instance, the camera 111 may be externally controlled via a camera adapter 112 so that camera parameters such as zoom, focus, exposure and shutter speed may be changed, and release operations and retrieval or deletion of images may be controlled. Software for requesting such camera control is loaded onto, for instance, the display adapter 102, and the user may control the camera 111 through a GUI (graphical user interface) displayed on the display 101.

In the present invention, a protocol for performing control between communication adapters need not be dependent on specific protocols such as UPnP or DLNA, and various protocols may be applied.

In addition to being mutually connected by the network 170, the communication adapters are also connected to an external network such as the Internet 180 via a router 150, and are capable of accessing an installation server 160. When necessary, each communication adapter accesses the installation server 160 and acquires installation modules or installation information retained by the installation server 160 to perform installation processing.

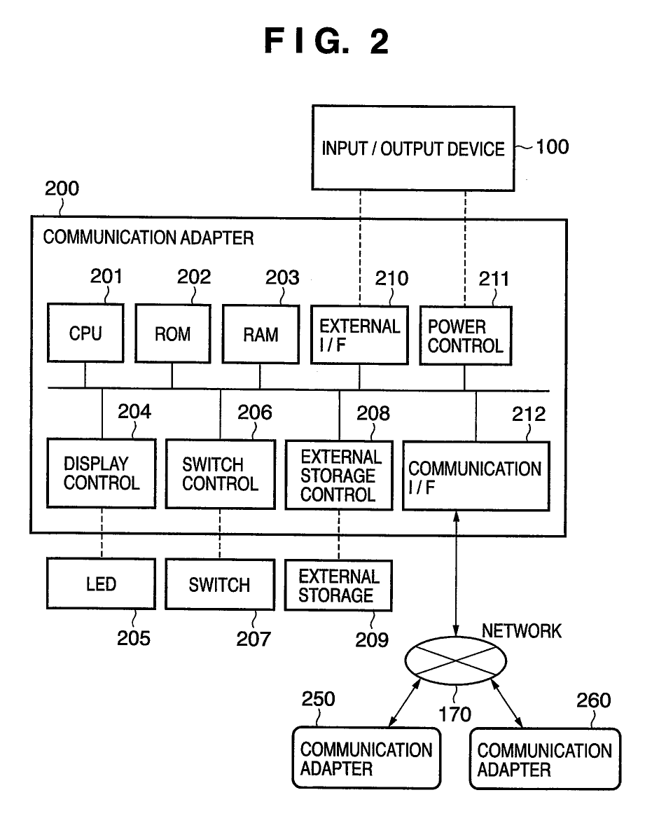

Next, a hardware configuration of a communication adapter (communication device) connected to an input/output device will be described with reference to FIG. 2. Note that the respective communication adapters (communication devices) basically have the same configuration.

FIG. 2 is a diagram showing an example of a hardware configuration of a communication adapter (communication device). In a manner similar to an ordinary computer, a communication adapter 200 comprises a CPU 201, a ROM 202 and a RAM 203. A rewritable flash ROM may be used as the ROM 202. In addition, a memory card such as a CF card or an SD memory card may be used as an external storage 209. The external storage 209 is controlled by an external storage control unit 208.

Furthermore, as display means, the communication adapter 200 comprises a display unit (LED) 205 and a display control unit 204. As input means, the communication adapter 200 also comprises a switch 207 and a switch control unit 206. Obviously, input devices such as a mouse or a keyboard, not shown, may also be connected. In addition, the communication adapter 200 may communicate with an input/output device 100 through an external interface 210 such as USB. Supply of power and control of power via a power control unit 211 may be performed for the input/output device. Furthermore, a communication interface 212 is used for communication with the network 170. The communication interface 212 supports wired LAN or wireless LAN.

Next, software configurations of an input/output device and a communication adapter will be described. Software of the communication adapter 200 includes various drivers for input/output interfaces of a LAN or a memory card, an OS (operating system), firmware, specific libraries and the like. In this case, specific libraries are called by firmware to perform communication protocol stack related to video transfer such as HTTP or RTP, decoding of MPEG2 or MPEG4, and image processing such as motion detection and face detection. HTTP is short for HyperText Transfer Protocol, and RTP is short for Real-Time Transport Protocol.

On the other hand, the communication adapter 200 is capable of realizing various functions by updating firmware or installing libraries when necessary. A multiprocessing OS running on the communication adapter 200 allows processes for an HTTP server, an FTP server, a LOG daemon and the like to run simultaneously as firmware, in addition to control processes of devices. For instance, at an input communication adapter, a server process runs which transmits images in response to a request from another communication adapter and mediates control over devices. On the other hand, at a display communication adapter, a plurality of applications having GUIs run to display device status for a user or to control devices.

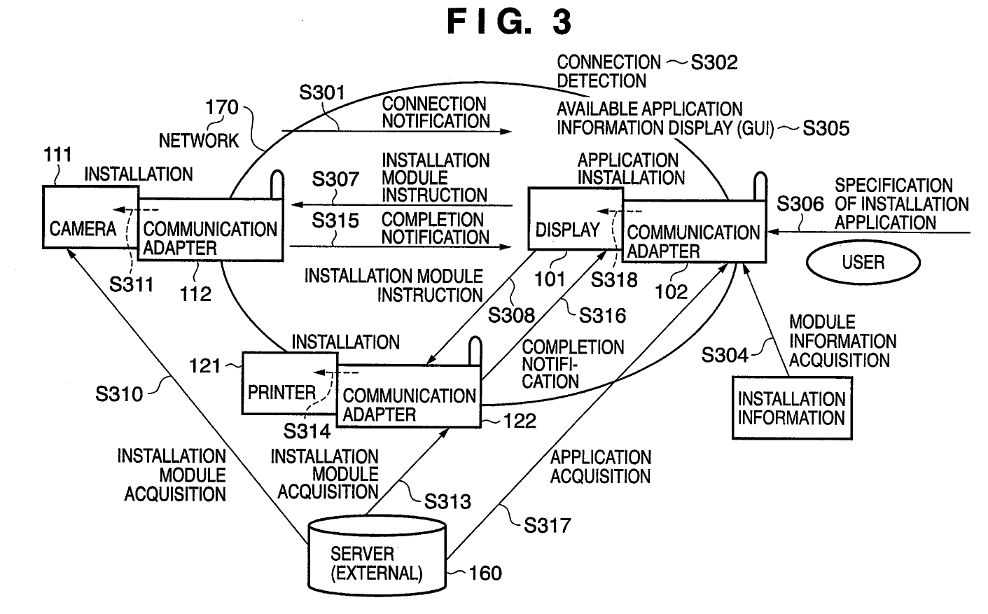

Next, an outline of a software installation procedure according to the first embodiment will be described with reference to FIG. 3.

FIG. 3 shows a system configured of a plurality of input/output devices connected to the network 170 via communication adapters (communication devices) in the same manner as the system shown in FIG. 1. For illustrative purposes, a display, a camera, a printer and their respective communication adapters are used. Information regarding installation is retained by the display adapter 102. A description method of this information will be described later.

In the system shown in FIG. 3, it is assumed that a display 101 and a display adapter 102, a printer 121 and a printer adapter 122 are already running. FIG. 3 shows a procedure of a case in which a software module for a communication adapter is installed when a camera 111 and a camera adapter 112 are newly activated.

First, in step S301, a connection notification is issued from the camera adapter 112 to another communication adapter. Next, in step S302, the display adapter 102 detects the connection notification. A mechanism of connection notification and detection thereof may be realized by, for instance, using UPnP. At this point, upon detection of a new communication adapter (new communication device), the display adapter (communication device) 102 in step S304 references installation information in a built-in RAM 203. Next, for each communication adapter, the display adapter 102 acquires from the RAM 203 information on applications that become available due to the new connection of the camera adapter 112 and module information required by the applications.

Next, in step S305, based on the acquired information, the display adapter 102 displays a list of applications (services) that become available after installation on the display unit 101. Subsequently, in step S306, a user specifies an application that the user desires to install.

When an installation application is determined in this manner, in step S307, the display adapter 102 issues an installation module instruction to the camera adapter 112. In response thereto, in step S310, the camera adapter 112 acquires an installation module from the installation server (server device) 160, and in step S311, performs installation. Additionally, in step S308, the display adapter 102 issues an installation module instruction to the printer adapter 122. In response thereto, in step S313, the printer adapter 122 acquires an installation module, and in step S314, installs the module.

Once installation is completed, in steps S315 and S316, each communication adapter notifies completion of installation to the display adapter 102.

After receiving installation completion notifications from the respective communication adapters, in step S317, the display adapter 102 downloads an application from the installation server 160, and installs the application in step S318 to complete the present series of installation processing.

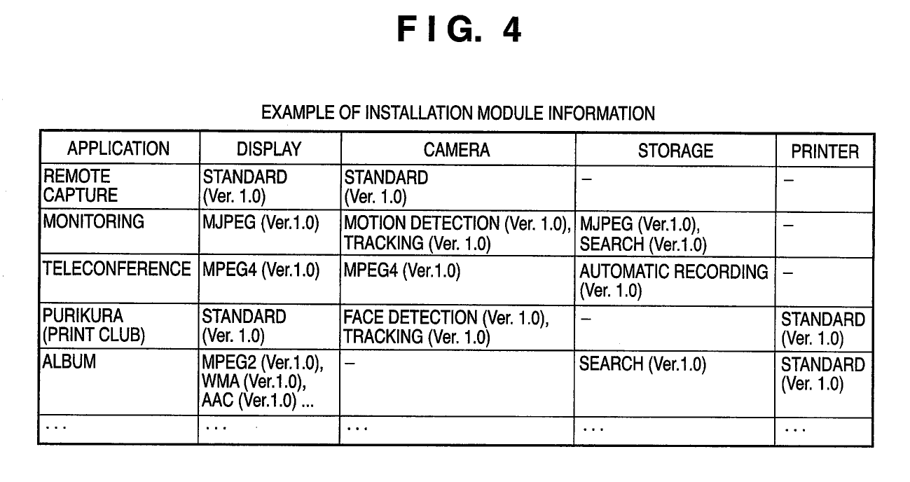

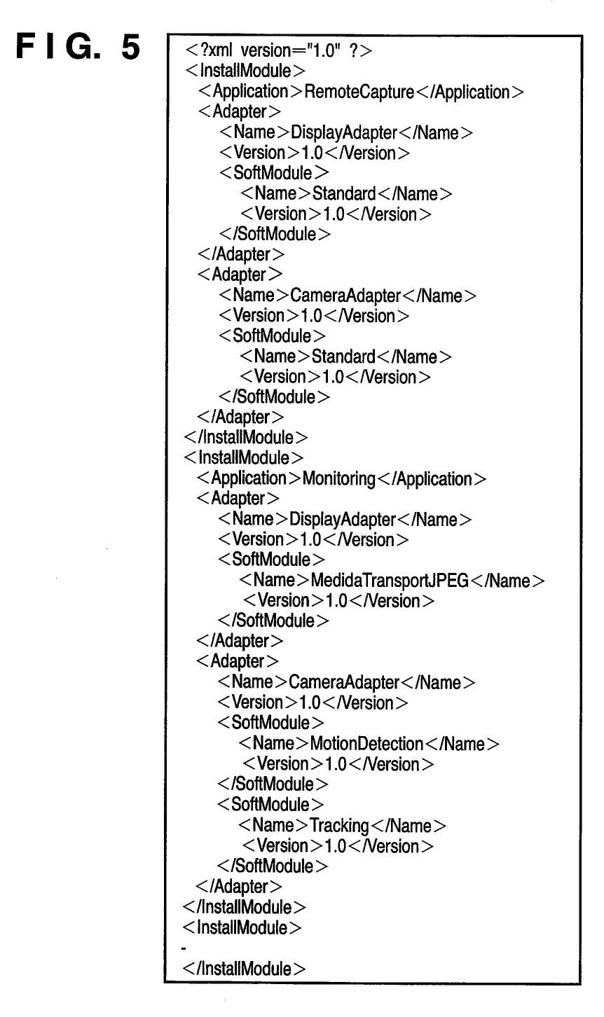

Contents and a description method of installation information to be installed in an input/output device will now be described with reference to FIGS. 4 and 5.

FIG. 4 is a diagram showing contents of installation information according to the first embodiment. As shown in FIG. 4, installation information is a description containing applications to be executed by the display adapter 102, communication adapters necessary for executing the applications, and modules required at the respective communication adapters.

For instance, as shown in FIG. 4, communication adapters and software modules required for a remote capture application are a display adapter having a standard module and a camera adapter having a standard module. The versions of the respective modules are both 1.0. It is needless to say that each communication adapter is connected to an input/output device.

Similarly, communication adapters and software modules required for a monitoring application are a display adapter having a Motion-JPEG decoding module in addition to a standard module, and a camera adapter having a motion detection module and a tracking module. The versions of the respective modules are all 1.0.

FIG. 5 is a diagram showing an example of an XML-format description of the contents of installation information shown in FIG. 4. In FIG. 5, a portion sandwiched between two <InstallModule> tags represent an installation module with respect to an application. An application name is described after an <Application> tag, a name and version of a communication adapter is described after an <Adapter> tag, and a list of names and versions of required modules is provided after a <SoftModule> tag.

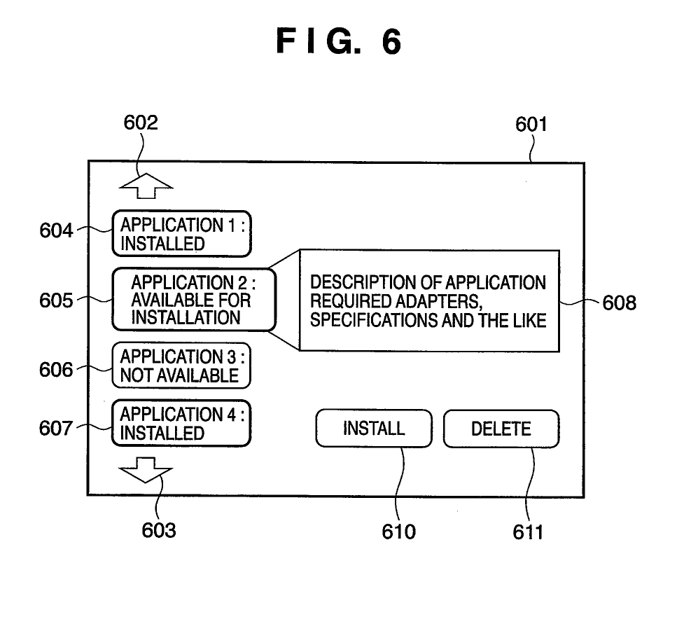

Next, an example of a GUI displayed on the display 101 will be described with reference to FIG. 6. FIG. 6 is a diagram showing an example of a GUI displaying an installation application on an input/output device. Reference numeral 601 denotes a window on the display or otherwise the entire display, and icons 604 to 607 of the application are displayed therein. In this case, the icons 604 and 607 represent applications already installed, while the icon 606 represents an application that is uninstallable. An uninstallable application is an application which may not be installed due to an insufficient number of necessary communication adapters.

The icon 605 represents an application that is installable among the uninstalled applications. Icons of such applications are highlighted. In addition, a description 608 of the application represented by the icon 605 is displayed.

An application icon may be selected by pressing the cursor buttons 602 and 603 or pressing cursor keys. When the icon 605 of the installable application is in focus, an installation button 610 is activated. When the user presses this button 610 (step S306 in FIG. 3), module installation instructions (steps S307 and S308) are transmitted from the display adapter 102 to the respective communication adapters.

While icons of all applications are displayed in the example shown in FIG. 6 for the sake of convenience, a GUI may be used which displays only installable applications.

By displaying installable software on a screen and allowing a user to select software to perform installation, only necessary software will be installed.

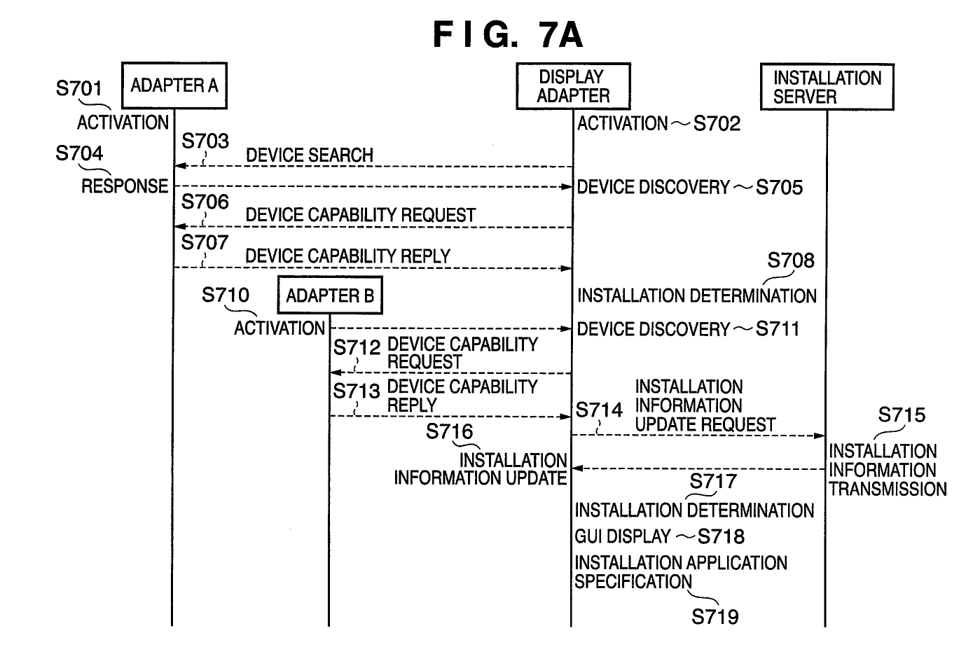

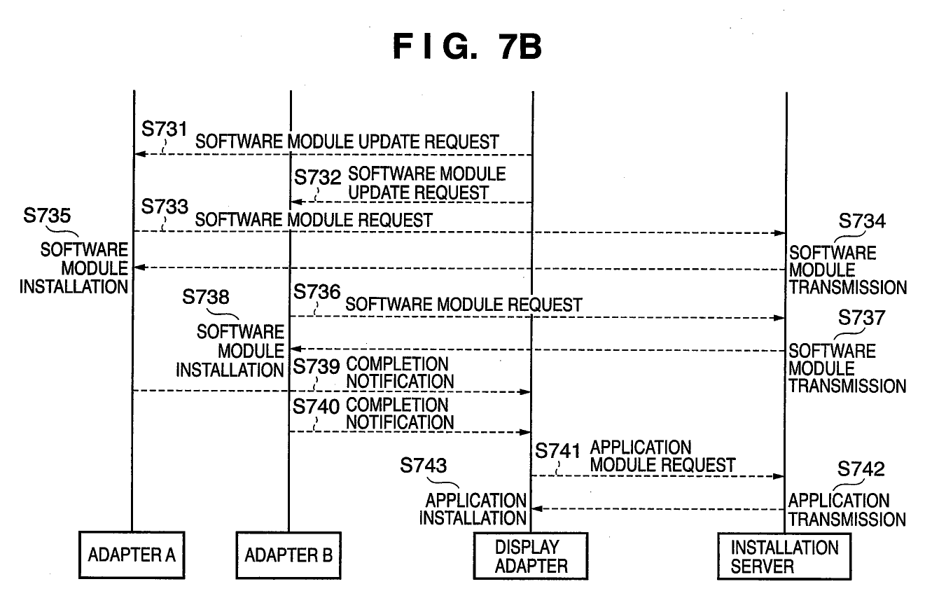

Next, a procedure of processing by the respective communication adapters (communication devices) and the installation server (server device) will be described in detail with reference to FIGS. 7A and 7B. The example shown in FIGS. 7A and 7B illustrates a correlated communication procedure of communication adapters A and B, the display adapter 102, and the installation server 160. The communication adapters A and B, which are connected to input/output devices other than the display adapter 102 (for instance, the printer adapter 122 and the camera adapter 112), need not be limited to specific communication adapters.

FIGS. 7A and 7B are diagrams showing a procedure of processing performed by the display adapter (communication device) 102 for determining installation to another communication adapter. First, the communication adapter A is activated in step S701, and the display adapter 102 is activated in step S702. This activation sequence may be reversed. After activation, in step S703, the display adapter 102 searches for communication adapters on a network 170. In response thereto, in step S704, the communication adapter A returns a response to the search request. The display adapter 102 receives the response in step S705, and discovers the communication adapter A. In response thereto, in step S706, the display adapter 102 requests capability of the communication adapter. In step S707, the communication adapter A returns information (service list) including connected devices, services provided by the connected devices, installation modules and versions thereof. The above-described mechanism may be realized using, for instance, UPnP.

After receiving the capability of the communication adapter A, in step S708, the display adapter 102 references the received capability information together with service information in the built-in RAM 203, and determines whether a newly installable application exists. In this case, it is assumed that the display adapter 102 will determine that no modules will be newly installed when the communication adapter A has been connected before and no newly installable applications exist.

Next, in step S710, the communication adapter B is activated. The communication adapter B has never been connected before. The communication adapter B issues an activation notification (connection notification) and, in step S711, the display adapter 102 detects this notification (connection detection). Next, in response to a request made by the display adapter 102 in step S712 for the capability of the communication adapter B, the communication adapter B returns its capability (service list) in step S713. A method in which the communication adapter B is activated afterwards and notifies activation may also be realized using UPnP.

At this point, if the installation module information in the built-in RAM 203 is old, in step S714, the display adapter 102 requests the installation server 160 to update installation information. In response thereto, in step S715, the installation server 160 returns installation information, and in step S716, the display adapter 102 updates the installation information stored in the built-in RAM 203. The update of installation information may be performed immediately prior to determination installation, as described above, or upon activation. Alternatively, updating may be performed on a regular basis.

Next, determination of installation is performed in S717. Since the communication adapter B is an adapter (new communication device) connected to a new device that has not been connected before, an application (service) may possibly exist which becomes newly available due to a combination with an existing communication adapter. Therefore, the display adapter 102 references the installation information in the built-in RAM 203 shown in FIG. 5 to discriminate installable applications. In step S718, the display adapter 102 displays a GUI (available application display) such as that shown in FIG. 6, and prompts the user to specify an application. Subsequently, if an application is specified by the user in step S719, the respective communication adapters are requested to install modules (software) necessary for the application (service) in step S731 and thereafter.

First, in step S731, the communication adapter A is requested to install a software module, and in step S732, the communication adapter B is also requested to install a software module. These requests are performed by transmitting an instruction (installation module instruction), with a list of modules to be installed attached thereto, to the communication adapters A and B. Upon receiving the installation request, in step S733, the communication adapter A requests the installation server 160 for a software module. In response thereto, in step S734, the installation server 160 returns the module. After receiving the module, the communication adapter A installs the module in step S735. If there is a plurality of software modules to be installed, the above steps S733 to S735 are repeated. In addition, the communication adapter B performs installation in steps S736 to S738 following the same procedure.

Once installation is completed, in steps S739 and S740, each communication adapter transmits a completion notification to the display adapter 102. This enables the display adapter 102 to confirm that installation of software modules necessary for the application has been completed at all communication adapters.

In step S741, a request is made to the installation server 160 for an application module. In step S742, the installation server 160 transmits the application module. Next, in step S743, the display adapter 102 receives and installs the application module, and displays completion of installation on the display screen to conclude all processing related to installation. The request for an application module issued in step S741 may alternatively be issued without waiting for the completion notification of steps S739 and S740.

As seen, according to the first embodiment, the installation server 160 provides the display adapter 102 with installation information. This installation information comprises communication adapters and software modules necessary for an application running on the display adapter 102. In addition, when a communication adapter is connected to a network, the installation information is referenced to have a user select an installable application. In addition, software modules necessary for executing the application selected by the user are notified to each communication adapter. Furthermore, upon receiving the notification, the respective communication adapters download the software modules from the installation server and install the software modules.

As a result, applications that are actually available according to the system configuration may be installed. Additionally, software modules that run on related communication adapters may be collectively installed by merely issuing an installation instruction using the display adapter.

### Second Embodiment

Next, a second embodiment according to the present invention will be described in detail with reference to the drawings. In the second embodiment, each communication adapter (communication device) retains installation information, and uses its own discretion to install software modules related to executable applications or solutions. In this case, “solution” refers to a service that may be realized using a combination of a plurality of communication adapters, such as a function in which a camera adapter requests a printer adapter to print photographs stored in a camera. In other words, the communication device detects another network device, and determines software to be respectively used by the communication device and the other device to cooperate with each other. The communication device then installs the determined software.

In the second embodiment, the display adapter need not exist on a network. More specifically, even in a case where only the camera adapter and the printer adapter are running, software modules required by each communication module may be automatically determined, acquired and installed.

Since a system configuration according to the second embodiment is the same as that used in the first embodiment and shown in FIG. 3, a description thereof will be omitted.

In the same manner as shown in FIG. 3, a display 101, a camera 111 and a printer 121 are respectively connected to a network 170 via communication adapters 102, 112 and 122. In addition, an installation server 160 is provided which may be accessed via the Internet 180.

A situation will now be considered in which the display adapter 102 and the printer adapter 122 are already connected on the network 170, and the camera adapter 112 is about to be newly connected. Automatic determination is made on whether a module should be installed by each communication adapter in response to the connection of the camera adapter 112.

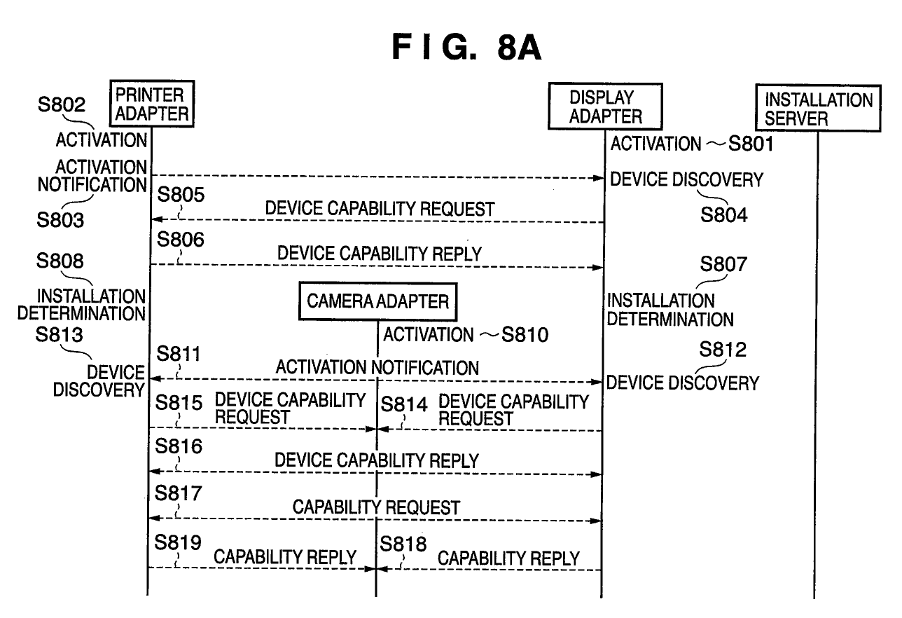

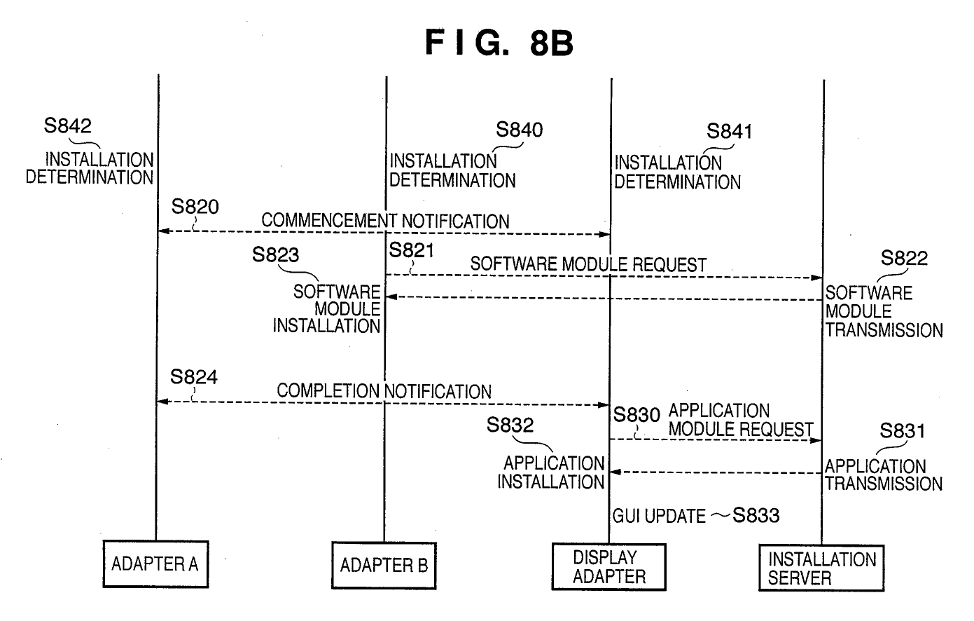

Next, a procedure of processing of the respective communication adapters (communication devices) and the installation server (server device) will be described in detail with reference to FIGS. 8A and 8B.

FIGS. 8A and 8B are diagrams showing a procedure of processing when each communication adapter on the network performs installation determination. Prior to activation of the camera adapter 112, the display adapter (communication device) 102 is first activated in step S801, and the printer adapter 122 is activated in step S802. Next, in step S803, the printer adapter 122 notifies its activation (connection) to the display adapter 102. In step S804, the display adapter 102 discovers the printer adapter 122. Next, in step S805, the display adapter 102 issues a capability request to the printer adapter 122. In step S806, the printer adapter 122 sends back information on available services and functions, and information on installed software modules and their versions (service list). The printer adapter 122 may also gain knowledge on the capability of the display adapter 102 following a similar procedure. The above may be implemented using, for instance, UPnP.

After exchange of capabilities, in steps S807 and S808, the necessity of installation is determined. To be more specific, each communication adapter references installation information in a built-in RAM 203 to determine whether there is an application or a solution that becomes newly available, and if so, installs software modules necessary for executing the same. In this case, the description method of installation information is the same as that used in the first embodiment and shown in FIGS. 4 and 5.

While the application is a software module executable by the display adapter 102, the solution is a service that is executable regardless of the presence of the display adapter 102. In other words, there may be cases in which the field corresponding to the display adapter 102 in FIG. 4 will be left unfilled.

Returning now to the example shown in FIGS. 8A and 8B, since there are no newly available solutions for both the printer adapter 122 and the display adapter 102, updating will not be performed.

Upon activation of the camera adapter 112 in step S810, the camera adapter 112 issues an activation notification (connection notification) to the printer adapter 122 and the display adapter 102 in step S811. The respective communication adapters (communication devices) 102 and 122 discover the camera adapter (new communication device) 112 in steps S812 and S813, and request capability information in steps S814 and S815. In response thereto, the camera adapter 112 returns capability information (service list) in step S816.

Meanwhile, in the second embodiment, since each communication adapter is required to mutually acquire capability information, in step S817, the camera adapter 112 requests the other communication adapters on the network for capability information. In response thereto, in steps S818 and S819, the printer adapter 122 and the display adapter 102 return capability information. The procedure of steps S814 to S819 enable mutual acquisition of capability information (service lists). Such a mechanism may be realized using UPnP.

Next, in step S840, the camera adapter 112 references installation information in the built-in RAM 203 and determines an installation module. Since the camera adapter (communication device) 112 is a communication adapter (new communication device) that has been newly connected to the network, a module exists which must be newly installed. Therefore, in step S820, commencement of installation of the module is notified to the other communication adapters 102 and 122, and in step S821, a software module (software) request is issued to the installation server (server device) 160. The installation server 160 returns a software module in step S822, and installs the software module in step S823. After installation, in step S824, the camera adapter 112 notifies completion of installation to the other communication adapters 102 and 122.

In addition, after the exchange of capabilities performed in steps S815 to S819, the printer adapter 122 references installation information in step S842 to determine whether a module must be newly installed. If there are no new installable modules, installation will not be performed. In a similar manner, after the exchange of capabilities, the display adapter 102 also determines in step S841 whether there is a newly available application. In reality, since an application is newly available due to the introduction of the camera adapter 112, in step S830, a request for an application module is issued to the installation server 160. In response thereto, in step S831, the installation server 160 returns an application module, and in step S832, the display adapter 102 installs the module. Finally, in step S833, the display adapter 102 displays on a screen that an available application has been newly added.

In the second embodiment, each communication adapter retains installation information in the built-in RAM 203. Updating of installation information may be performed either upon activation of a communication adapter or immediately prior to installation determination, or through acquisition from the installation server on a regular basis such as daily.

According to the second embodiment, each communication adapter upon activation exchanges capabilities with communication adapters already existing on the network, references retained installation information, and searches for services that will become newly available due to combinations. Next, software modules necessary for the service are downloaded from the installation server and installed.

As a result, there is no longer any need to retain in advance software that will not be used in a communication adapter, and installation may be performed in a flexible manner according to the system.

In addition, even when updating of software of a communication adapter connected to a network results in a need to update software of other communication adapters, relevant software may be automatically updated.

### Third Embodiment

Next, a third embodiment according to the present invention will be described. With the third embodiment, installation information that was retained in the first and second embodiments is not necessary retained inside a communication adapter. Instead, for the third embodiment, installation information is stored at an external installation server 160, and a communication adapter downloads the installation information when performing installation determination.

Another possible method is arranged so that the installation server 160 is inquired for an installation module. More specifically, the communication adapter transmits capability information of the communication adapter detected on the network to the installation server 160. A name of an appropriate installation module is then returned from the installation server 160. The communication adapter once again requests the installation server 160 for this module, and subsequently installs the module.

### Fourth Embodiment

Next, a fourth embodiment according to the present invention will be described in detail with reference to the drawings. The fourth embodiment is arranged so that, when determining whether an application or a service is available, restrictions are applied based on capabilities of the communication adapters and the devices to which the communication adapters are connected, instead of merely on the combination of communication adapters.

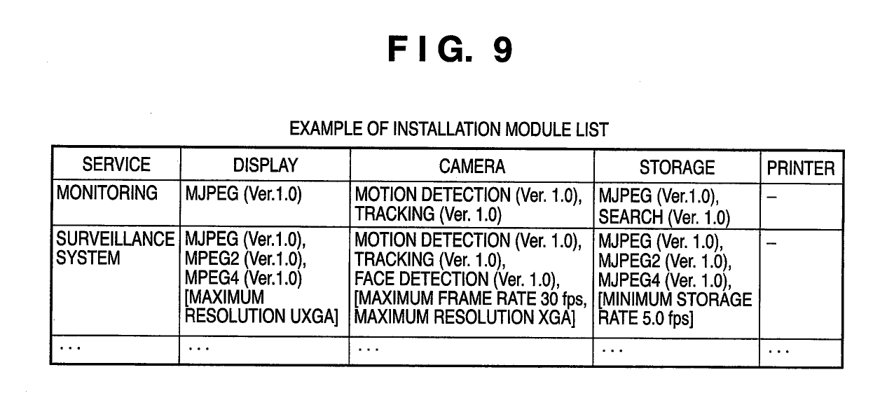

For instance, assume that a professional-use security monitoring application exists which requires the use of images with higher image quality and greater resolution, as well as a high frame rate. In this case, as a request to the camera adapter, the fact that these items must be guaranteed will be added to the installation information. In the specific example shown in FIG. 9, items such as maximum frame rate and maximum resolution are added to the camera adapter for a service named “monitoring system”. In a similar manner, there are cases in which a display with higher resolution will be required to output a large number of images. “Maximum resolution” will also be added as an additional item of the display.

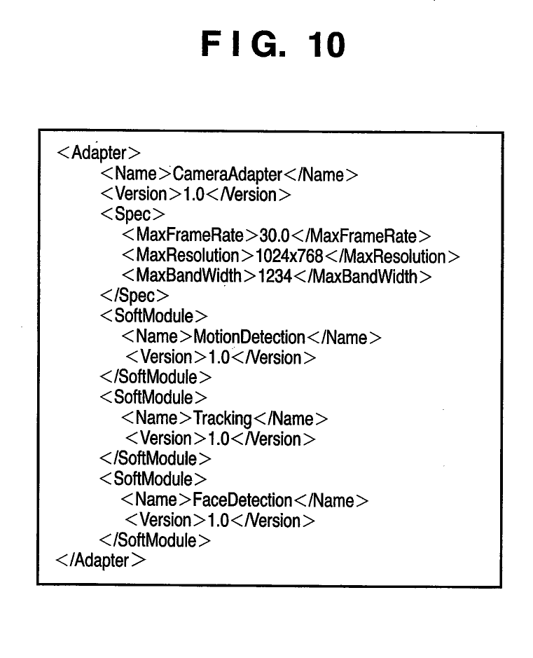

The installation module list shown in FIG. 9 may be expressed as a description file such as that shown in FIG. 10. In reality, a description file format such as that shown in FIG. 10 will be stored in an installation server. Upon installation, in the same manner as the first and second embodiments, capability exchange is performed between a detected communication adapter, and software modules necessary for the application or the solution are installed.

### Fifth Embodiment

Next, a fifth embodiment according to the present invention will be described. In the fifth embodiment, icons corresponding to applications or solutions for which modules have been installed but are temporarily unavailable due to circumstances of the devices are grayed out on a GUI of the display. An installed but unavailable state includes cases in which power of a device connected to a communication adapter has been turned off. In such a case, an unavailable state exists even when a communication adapter is detected and capability exchange has been performed.

In order to realize this function, the power of a device must be confirmed and the availability of the device must be determined. A hardware-based determination method involves determining power status using a power control unit 211. In addition, a software-based determination method involves adding an action for identifying the connection status of a device to server software that runs on a communication adapter, and calling the action after capability exchange to acquire connection status.

### Sixth Embodiment

Next, a sixth embodiment according to the present invention will be described. When a communication adapter that is not connected to an input/output device is connected to a network, a software module related to a device previously connected to the communication adapter is installed based on a history of previously-connected input/output devices. Since it is highly likely that a previously-connected device will be reconnected, only installation of a related module may be preformed in advance without having to actually connect the device.

In this embodiment, device description files and service description files of previously-connected input/output devices are stored inside the communication adapter. When the communication adapter independently connects to the network, activation notification is performed as if a device has been connected. However, among the variables and information that represent device status, information regarding device connection and power will be notified as being turned off. Otherwise, processing is the same as those performed in the first and second embodiments.

In a case where there is a history of a plurality of previously-connected devices, either the device last connected may be notified, or a device with the largest number of previous connections may be selected.

As described, by using a communication adapter in a state in which no devices are actually connected, installation of a software module may be performed prior to a connection of a device.

### Seventh Embodiment

Next, a seventh embodiment according to the present invention will be described in detail with reference to the drawings. With the seventh embodiment, a video output system that supports a video distribution service will be described.

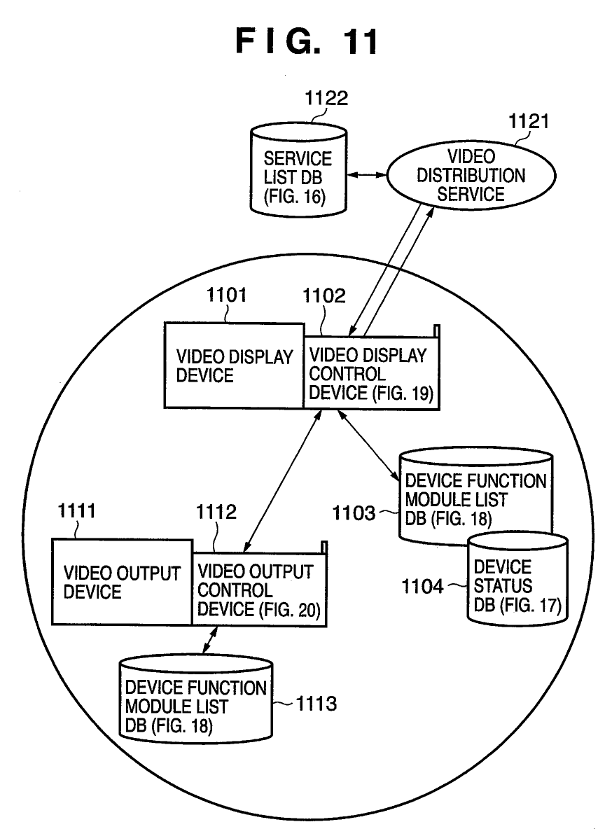

An outline of a video output system that supports a video distribution service, which comprises a video display control device and a video output control device, will be described with reference to FIG. 11.

FIG. 11 is a diagram showing an example of a configuration of the video output system that supports a video distribution service. In this case, a video data transmission system that supports mutual connection operations between devices on a network that complies with wired/wireless communication standards is assumed. The respective devices are connected by a common network protocol (such as TCP/IP).

As shown in FIG. 11, a video display control device 1102 and a video output control device 1112 are connected via a network. In addition, a video distribution service 1121 is a service that distributes videos requested by a user. A service list DB 1122 manages services that may be provided for video distribution by the video distribution service 1121 and user information. It is assumed that a user of the system has already completed user registration for the video distribution service.

The video display control device 1102 is connected to a video display device 1101, and possesses two databases, namely: a device function module list DB 1103, and a device status DB 1104. The device function module list DB 1103 is a database that manages information on applications installed on devices connected to the network. In addition, the device status DB 1104 is a database that manages information on current statuses and retained functions of devices connected on the network.

The video output control device 1112 is connected to a video output device 1111, and possesses a device function module list DB 1113. The device function module list DB 1113 is a database that manages application information of network devices. This information is similar to that retained in the device function module list DB 1103.

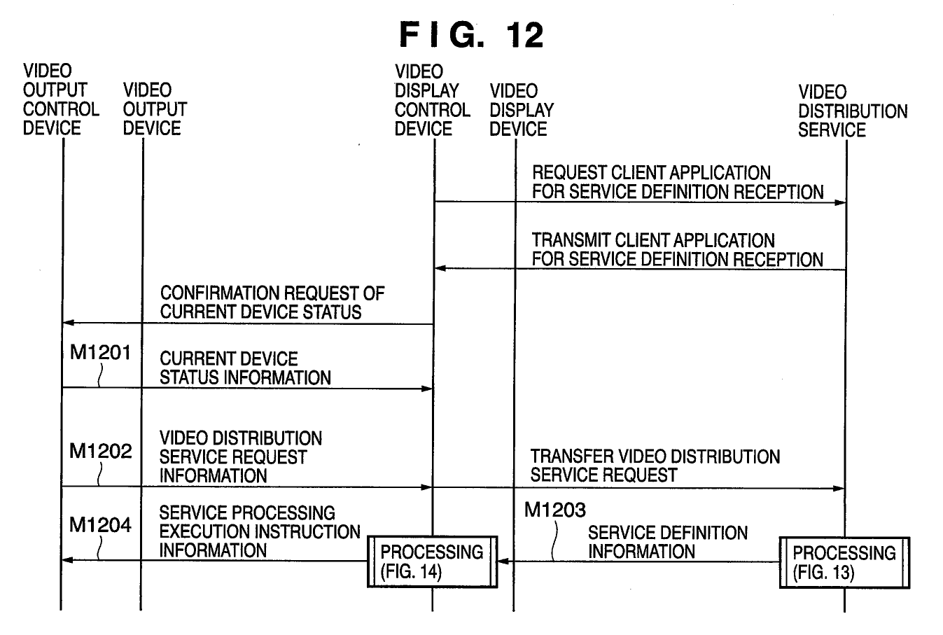

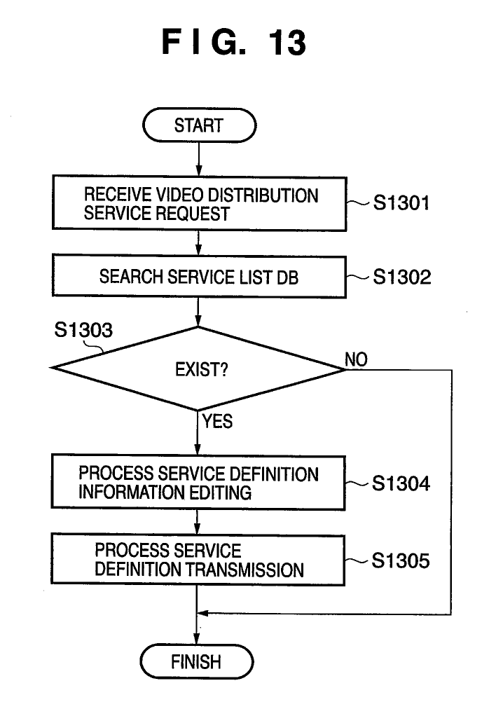

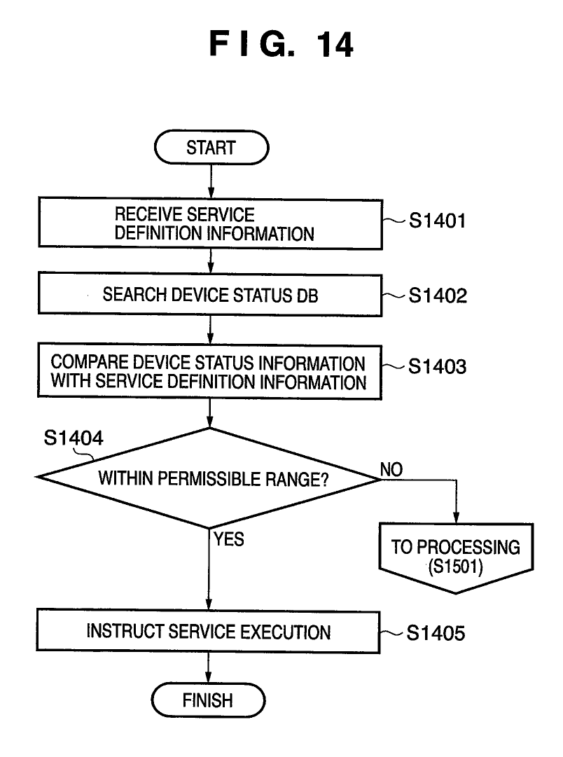

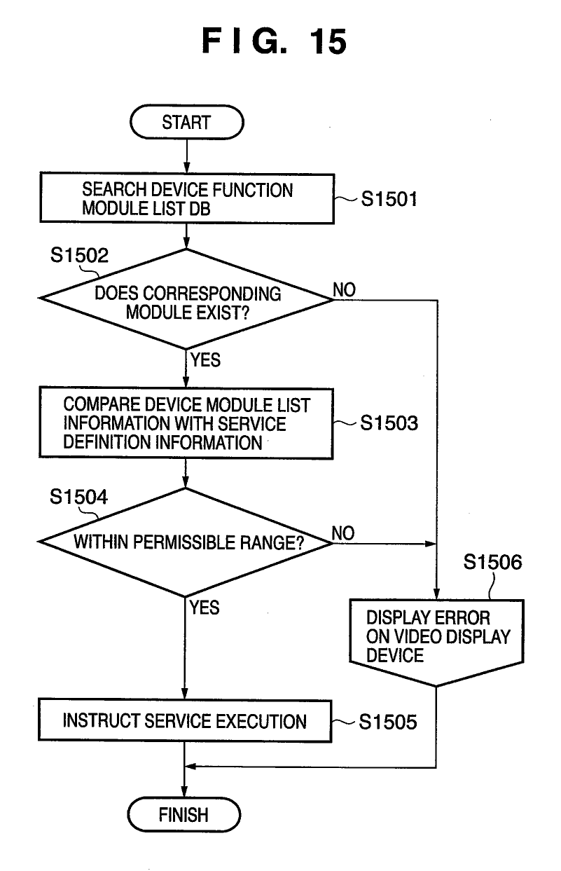

A sequence and processing flow according to the seventh embodiment will now be described with reference to FIGS. 12 to 15. FIG. 12 is a diagram showing a sequence and processing flow between devices according to the seventh embodiment. FIG. 13 is a flowchart showing processing that is called in FIG. 12. FIG. 14 is a flowchart showing processing that is called in FIG. 12. FIG. 15 is a flowchart showing processing that is called in FIG. 14.

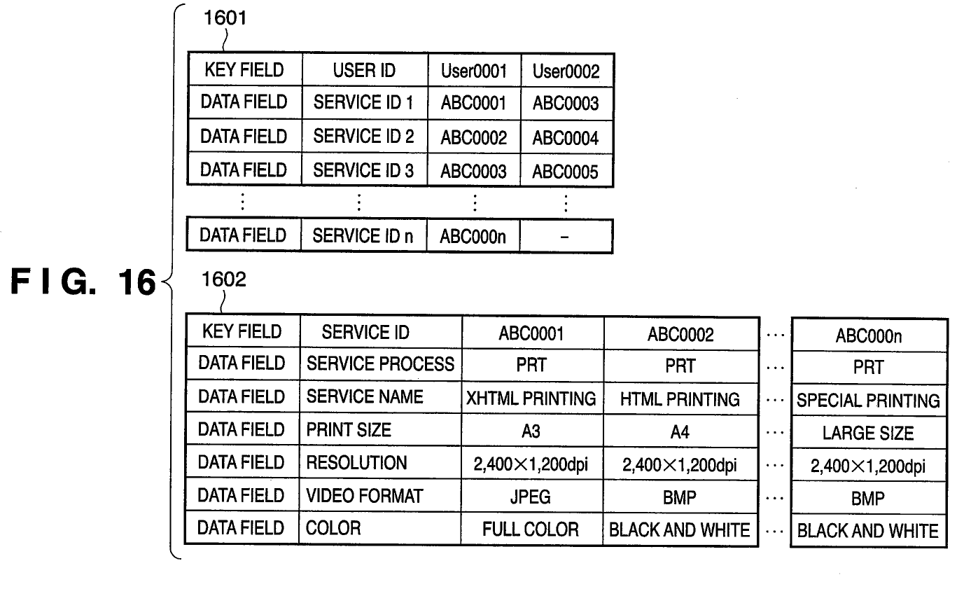

FIG. 16 is a diagram showing a configuration of the service list DB 1122. As shown in FIG. 16, DB layouts 1601 and 1602 have tabular configurations, and are formed so as to be hierarchically linked. The DB layout 1601 uses a user-registered user ID of the video distribution service as an item of a KEY field. This is a required item. A data field stores service IDs of one or more video distribution services. The service IDs are linked with service IDs which are items in a key field in the DB layout 1602. There are no unlinked service IDs. The data field stores specific contents of services.

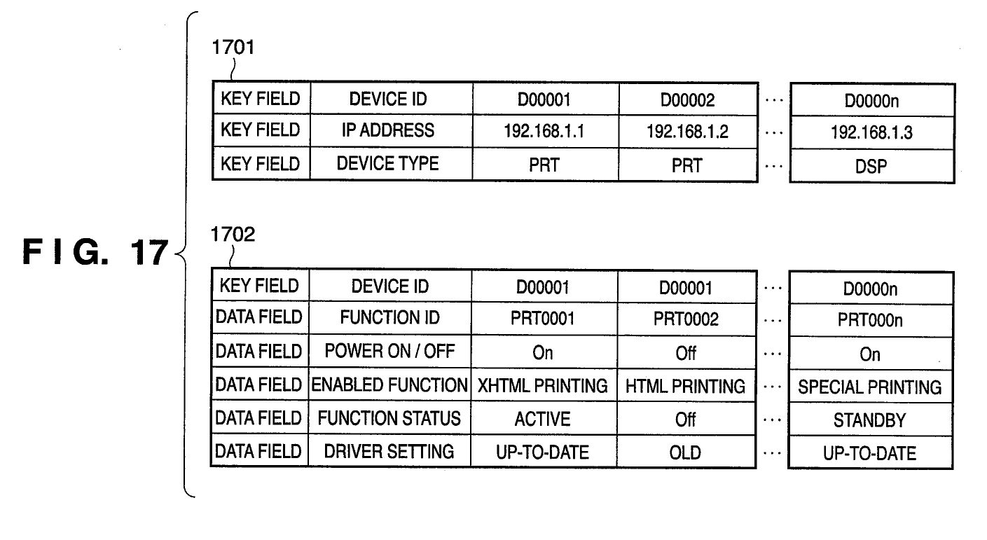

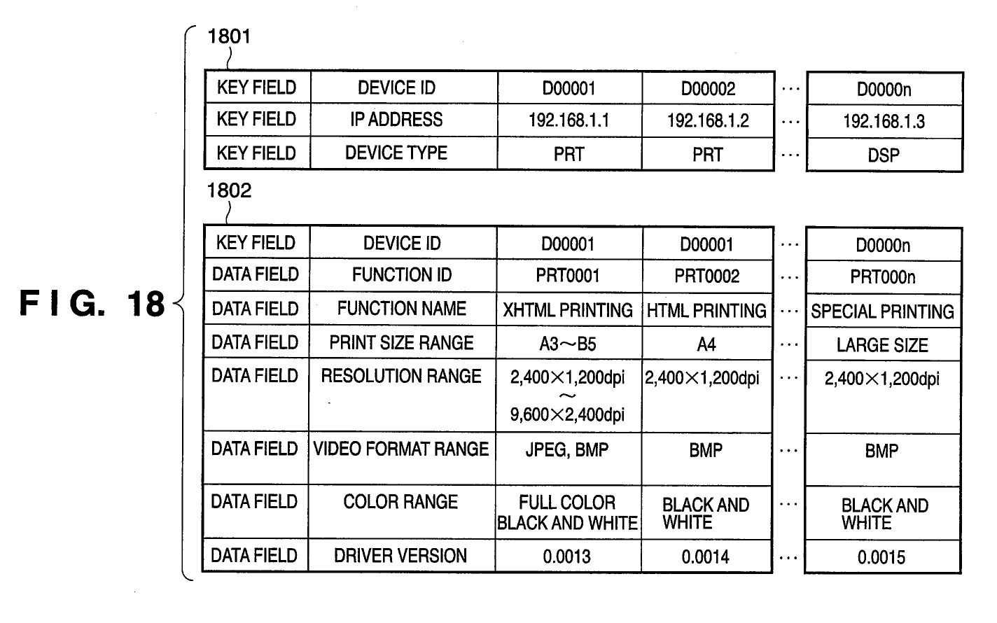

FIG. 17 is a diagram showing a configuration of the device status DB 1104. FIG. 18 is a diagram showing configurations of the device function module list DBs 1103 and 1113.

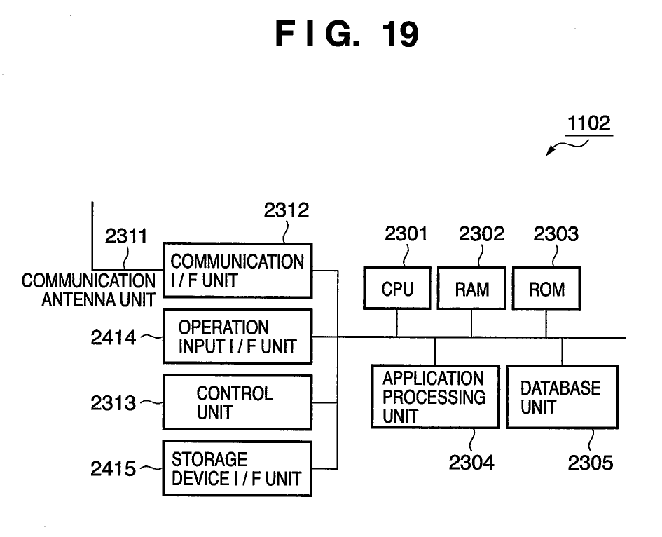

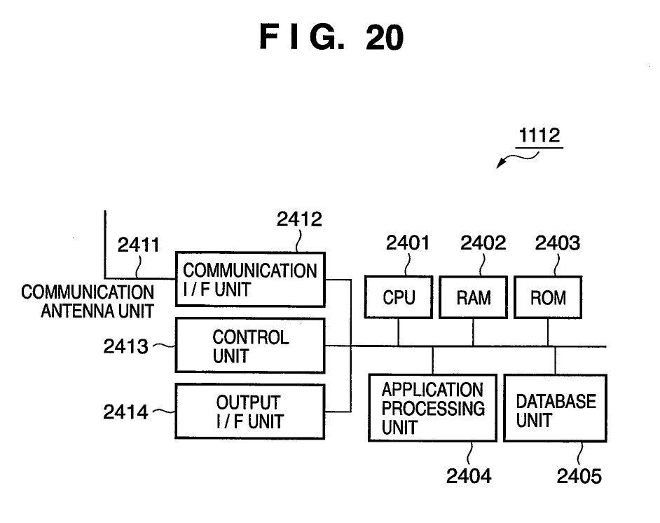

FIG. 19 is a diagram showing an example of a configuration of the video display control device 1102. FIG. 20 is a diagram showing an example of a configuration of the video output control device 1112. The configurations of the respective control devices are basically the same as the configuration of the communication adapter 200 used in the first embodiment and shown in FIG. 2.

With the present embodiment, necessary software modules are already installed in the respective control devices as described in the first to sixth embodiments.

A sequence and processing flow according to the seventh embodiment will now be described with reference to FIG. 12. The sequence and processing flow is performed by the video output device 1111 to realize video output processing in accordance with to video distribution data of a video distribution service, based on the various service requirements of the video distribution service.

First, preliminary processing for processing the video distribution service is performed. The video display control device 1102 requests the video distribution service 1121 for a client application for receiving a service definition. Upon receiving the request, the video distribution service 1121 authenticates whether the video display control device 1102 is a registered user of the service. If authentication is made without incident, a client application for receiving a service definition is transmitted to the video display control device 1102. The client application data for receiving a service definition is stored on a RAM 2302 via a communication I/F unit 2312 of the video display control device 1102, according to a control instruction of a control unit 2313.

Next, confirmation request processing of device status is performed. The video display control device 1102 transmits a current device status confirmation request to the video output control device 1112. Upon receiving the request, the video output control device 1112 collects the device status of the video output device 1111, sets the collected information to current device status information (communication message M1201), and transmits the information to the video display control device 1102. The device status is information such as power on/off shown in FIG. 17. When the video display control device 1102 receives the communication message M1201, if the device ID contained in the communication message M1201 does not exist in the device status DB 1104, the video display control device 1102 newly registers data contents of the communication message M1201 in the device status DB 1104. On the other hand, if the device ID exists, the video display control device 1102 overwrites and updates the data contents of the communication message M1201 with the device ID. During the device status confirmation request processing, new registration or overwrite and update is performed as needed at regular intervals determined by the present system.

Next, video distribution service request processing is performed. The video output control device 1112 transmits video distribution service request information (communication message M1202) to the video display control device 1102. The video display control device 1102 then transfers the communication message M1202 to the video distribution service 1121. The video distribution service request information (communication message M1202) includes a user ID and a service ID.

At this point, control shifts to the processing of the video distribution service 1121 shown in FIG. 13. First, in step S1301, the video distribution service 1121 receives the communication message M1202 (user ID and service ID). In step S1302, the video distribution service 1121 searches the service list DB 1122 based on the user ID in the communication message M1202 to confirm whether the user exists in the service list DB 1122. If it is determined in step S1303 that the user does not exist, the processing is terminated as is. However, if it is determined that the user exists, the processing proceeds to step S1304. In step S1304, service definition information (communication message M1203) is extracted from DB layouts 1601 and 1602 of the service list DB 1122 (FIG. 16). More specifically, if the service ID of the communication message M1202 is registered in the DB layout 1601 in correspondence to the user ID in the communication message M1202, service definition information (print size, resolution and the like) corresponding to the service ID (for instance, ABC0001) is extracted from the DB layout 1602. Subsequently, in step S1305, the video distribution service 1121 transmits the extracted service definition information (communication message M1203) to the video display control device 1102.

As a result, control shifts to the processing of the video display control device 1102 shown in FIG. 14. After receiving the communication message M1203 from the video distribution service 1121 in step S1401, in step S1402, the video display control device 1102 searches the device function module list DB 1103 based on the service ID of the communication message M1203. If the service processing of the received communication message M1203 (service definition information) is “PRT”, only data that have “PRT” as the upper three digits in their data items in the device function module list DB 1103 (FIG. 18) are extracted. Next, in step S1403, the extracted data and the service definition information (communication message M1203) are compared. In step S1404, a determination is made on whether there are devices that match each item or whether there are devices that are within range of each item.

For instance, in a case of print size, an inclusive comparison of maximum and minimum values is performed, while in a case of color, an inclusive comparison of color space is performed. If there is a device that matches or is within range, in step S1405, a service execution instruction (message M1204) is issued to the device (for instance, the video output control device 1112). The message M1204 is a message in which an entity of video data has been added to the message M1203. On the other hand, if no such devices are determined to exist in step S1404, control shifts to the processing shown in FIG. 15.

First, in step S1501, the device function module list DB 1103 is searched using a device ID, an IP address and a device type of the device status DB 1104 as key items. In step S1502, determination is made on whether a corresponding module exists. If so, in step S1503, device module list information is compared against service definition information. Next, in step S1404, determination is made on whether there are devices that match each item or whether there are devices that are within range of each item. For instance, in a case of output size, an inclusive comparison of maximum and minimum values is performed, while in a case of color, an inclusive comparison of color space is performed. If there is a device that matches or is within range, in step S1505, a service execution instruction is issued to the device that is in possession of the module, and the processing is thereby concluded.

Additionally, if no corresponding modules exist in the above-described step S1502, or if a device is not within an allowable range in step S1504, an error message is displayed on the video display device 1101 in step S1506, and the processing is thereby concluded.

According to the seventh embodiment, based on the various service requirements of a video distribution service, a video output device may realize video output processing according to video distribution data of the video distribution service.

In addition, an input/output device may be provided with highly reliable processing execution by automatically collecting functions and capabilities among input/output devices, performing automatic arbitration and determination of matches in processing conditions among devices, and installing necessary functions.

### Other Embodiments

The present invention may be applied to either systems comprising a plurality of devices (for example, a host computer, an interface device, a reader or a printer), or apparatuses composed of a single device (for example, a copying machine or facsimile machine).

In addition, the present invention may be configured by supplying a storage media that stores a program code capable of realizing the functions of the above-described embodiments to a system or an apparatus, and having a computer (CPU or MPU) of the system or apparatus read out and execute the program stored in the storage media.

In this case, the program code itself that is read out from the storage media achieves the functions of the above mentioned embodiments, while the storage media storing the program code will configure the present invention.

Storage media for supplying the program code may include, for instance, a flexible disk, a hard disk, an optical disk, a magneto-optical disk, a CD-ROM, a CD-R, a magnetic tape, a nonvolatile memory card, a ROM or the like.

Furthermore, the present invention is not limited to configurations in which the functions of the above-described embodiments are realized by executing a program code read out by the computer. More specifically, the functions of the aforementioned embodiments may also be achieved by having an OS (operating system) or the like running on the computer perform a portion or all of the actual processing based on instructions from the program code.

In addition, the scope of the present invention also includes configurations in which a program code read out from a storage media is written onto a function enhancement board inserted into a computer or a memory built into a function enhancement unit connected to a computer. In such a configuration, the functions of the aforementioned embodiments are achieved by having a CPU or the like built into the function enhancement board or the function enhancement unit perform a portion or all of the actual processing based on instructions from the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-112756, filed Apr. 14, 2006, which is hereby incorporated by reference herein in its entirety.

What is claimed is:

1. A software installation method, comprising the steps of:
detecting a device on a network;
determining software to be used by each of a plurality of devices including the detected device to allow the plurality of devices to cooperate with each other; and
installing the determined software to each of the plurality of devices.

2. The method according to claim 1, wherein, in the installing step, the determined software is installed in a device that is an adapter for connecting a data processing apparatus to the network.

3. The method according to claim 2, wherein, in the determining step, software is determined based on the data processing apparatus previously connected to the adapter.

4. The method according to claim 1, wherein, in the determining step, software to be used by the detected device is determined to be notified to the detected device.

5. The method according to claim 1, wherein, in the determining step, each of the plurality of devices respectively determines software to be used based on functions of other devices.

6. The method according to claim 1, wherein, in the determining step, software is determined based on a device required for an application and software information required for the device.

7. The method according to claim 1, wherein, in the determining step, software to be respectively used by each of the plurality of devices in order to execute a selected application is determined.

8. The method according to claim 1, wherein the installing step includes a step of distributing contents using the installed software.

9. The method according to claim 1, wherein the installing step includes a step of determining whether the installed software is available.

10. A communication apparatus that cooperates with a device on a network, comprising:
detection means for detecting a device on the network; and
notification means for notifying the device on the network of software to install in order to cooperate with the device on the network.

11. The apparatus according to claim 10, further comprising connection means for connecting a data processing apparatus, wherein said notification means notifies the device on the network of software corresponding to the data processing apparatus connected by said connection means.

12. The apparatus according to claim 10, wherein the notification means comprises installation means for installing software, and notifies the device on the network of software corresponding to software to be installed by said installation means.

13. A communication apparatus that cooperates with a device on a network, comprising:
detection means for detecting a device on the network;
installation means for installing software to be installed in order to cooperate with the device on the network; and
notification means for notifying the device on the network of information to be used to determine software to be installed in order to cooperate with the device on the network.

14. The apparatus according to claim 13, further comprising connection means for connecting a data processing apparatus, wherein said notification means notifies the device on the network of information corresponding to the data processing apparatus connected by said connection means.

15. A computer program for causing a computer comprised of a communication apparatus that cooperates with a device on a network to execute a method, the method comprising the steps of:
detecting a device on the network; and
notifying the device on the network of software to install in order to cooperate with the device on the network.

16. The computer program according to claim 15, wherein the notifying step notifies the device on the network of software corresponding to a connected data processing apparatus.

17. The computer program according to claim 15, wherein the notifying step includes a step for installing software, and notifies the device on the network of software corresponding to software to be installed.

18. A computer program for causing a computer comprised of a communication apparatus that cooperates with a device on a network to execute a method, the method comprising the steps of:
detecting a device on the network;
installing software to be installed in order to cooperate with the device on the network; and
notifying the device on the network of information to be used to determine software to be installed in order to cooperate with the device on the network.

19. The computer program according to claim 18, wherein, in the notification step, the device on the network is notified of information corresponding to a connected data processing apparatus.
